(19) United States
(12) Patent Application Publication
(10) Pub. No.: US 2023/0257839 A1
(43) Pub. Date: Aug. 17, 2023

(54) A method of casting a steel semi-product with high titanium content

(71) Applicant: ArcelorMittal, Luxembourg (LU)

(72) Inventors: Frédéric BONNET, Avril (FR); Valérie DAESCHLER, Maizières-Lès-Metz (FR); Thierry MASTRORILLO, Maizières-Lès-Metz (FR)

(21) Appl. No.: 18/014,434

(22) PCT Filed: Jul. 7, 2021
(86) PCT No.: PCT/IB2021/056078

§ 371 Date: Jan. 4, 2023

(30) Foreign Application Priority Data
Jul. 8, 2020 (WO) PCT/IB2020/056418

(51) Int. Cl. C21C 7/00; B22D 11/00; C21C 7/06; C22C 38/54; C22C 38/50; C22C 38/48; C22C 38/44; C22C 38/42; C22C 38/06; C22C 38/04; C22C 38/02; C22C 38/00; C22C 38/46

(52) U.S. Cl. CPC C21C 7/0037; B22D 11/001; C21C 7/06; C21C 7/0087; C22C 38/54; C22C 38/50; C22C 38/48; C22C 38/44; C22C 38/42; C22C 38/06; C22C 38/04; C22C 38/02; C22C 38/002; C22C 38/001; C22C 38/46; C21C 2007/0018

(57) ABSTRACT

A method of casting a steel semi-product from a liquid steel, the steel semi-product having a targeted composition in titanium of at least 3.5% in weight.

The invention is related to the casting of steel semi-product having a high titanium content.

FeTiB2 steels have been attracting much attention due to their excellent high elastic modulus E, low density and high tensile strength which makes them very promising for the automotive industry, where vehicle lightening, and safety are constant preoccupations. However, those steels are difficult to manufacture due to constraints linked to the precipitates to be formed. Different solutions have thus been developed to produce such steels and notably to solve castability issues.

### BACKGROUND

US20130174942 discloses a FeTiB2 steel comprising between 2.5 and 7.2% w of Ti which is cast at a casting temperature not exceeding more than 40° C. above the liquidus temperature of said steel. This allows to have a fine microstructure.

EP3612657 discloses a specific composition of the steel wherein the content in free Ti of the steel is of at least 0.95%, and owing to this content in free Ti, the structure of the steel remains mainly ferritic at any temperature below the liquidus temperature. As a result, the hot hardness of the steel is significantly reduced as compared to the steels of the state of the art, so that the castability is increased. Casting is preferably performed in the form of thin slabs.

However, whatever the type of casting method, it requires that the liquid steel arrives at the tapping station with the right composition, temperature and viscosity. For those specific grades this step is one of the most difficult to handle. During the steelmaking, depending on the slag composition and temperature, some components of the slag may precipitate. In the case of high titanium grades, titanium tends to partition and migrate towards the slag and as titanium oxides tend to precipitate at the casting temperature, the crystallisation rates of the slag increase drastically. A good crystallization rate for a steelmaker is when samples of molten metal may be taken, while in the same time, such slag is still covering the molten metal to avoid contact with air.

There is so a need for a casting method allowing to cast steel semi-products having a high content in titanium, i.e, superior to 3.5% in weight.

This problem is solved by a method, wherein following steps are performed:

A/ addition of aluminum to the liquid steel so that liquid steel contains at least 0.1% in weight of aluminum,

B/ addition to the liquid steel of mineral compounds containing aluminum and/or calcium and optionally magnesium and CaF2, to reach and maintain a slag composition wherein the ratio of CaO versus Al2O3 (CaO/Al2O3) is comprised from 0.7 to 2, the slag containing up to 25% in weight of CaF2,

C/ addition of titanium to the liquid steel to reach the targeted composition,

D/ casting the steel in the form of a semi-product.

The method may also comprise the following optional characteristics considered separately or according to all possible technical combinations:
the amount of aluminum added is such that the liquid steel contains more than 0.2% in weight of aluminum, preferably more than 0.4% in weight
the steel semi-product contains boron in a minimum percentage in weight fulfilling following equation: % B≥0, 45x%Ti−1.35%
between steps A and B, a heating step of the liquid steel is performed,
a step of addition of boron is performed after step C,
an addition of boron is performed during step B, during step B, spar CaF2 is added so as to reach a composition in CaF2 comprised from 6 to 15%in weight,
during step B, magnesia is added so as to reach a composition in MgO of the slag comprised from 5 to 15% in weight,
during step B addition of mineral compounds is done to reach a slag composition wherein the ratio of CaO versus Al₂O₃ (CaO/Al2O3) is comprised between 0.9 and 1.3,
addition of mineral compounds is done to reach a slag composition wherein the ratio of CaO versus Al₂O₃ (CaO/Al2O3) is comprised between 1.4 and 2, the slag furthermore comprising between 6 and 12% in weight of CaF2,
the steel semi-product has a targeted composition in titanium of at least 5.8% in weight,
the mineral compounds are chosen among lime, spar and magnesia,
the steel semi-product has the following composition expressed in content by weight:

0.01%≤C≤0.2%

3.5≤Ti≤10%

(0.45×Ti)−1.35%≤B≤(0.45×Ti)+0.70%

S≤0.03%

P≤0.04%

N≤0.05%

O≤0.05%

and optionally containing:

Si≤1.5%

Mn≤3%

Al≤1.5%

Ni≤1%

Mo≤1%

Cr≤3%

Cu≤1%

Nb≤0.1%

V≤0.5%

and comprising precipitates of TiB2 and optionally of Fe2B, the balance being Fe and unavoidable impurities resulting from the elaboration.

The invention is also related to a steelmaking slag having following composition, expressed in content by weight:

35%≤CaO≤55%,

15%≤Al203≤55%,

while satisfying 0.7≤CaO2/Al2O3≤2,

0% ≤MgO≤15%,

TiOx<20%

less than 1% of each of the following compounds B2O3, SiO2, CrOx, MnO, NiO, FeOx, S,

0%≤CaF2≤25%

remainder being oxides resulting from the impurities present in the molten metal.

### DETAILED DESCRIPTION

In one embodiment of the method according to the invention, the liquid steel (also called molten metal), which may either come from an electrical arc furnace or from any steelmaking device such as a Basic Oxygen Furnace or a converter is subjected to a deoxidation step. At that stage the liquid steel usually has a temperature around 1650° C. To perform deoxidation, aluminium is added to the molten metal, usually during ladle tapping to promote homogeneous reaction of deoxidation. According to the invention aluminium is added so that quantity in the molten metal is superior or equal to 0.1% in weight, which is superior than the usual amount required for deoxidation of liquid steel. In a preferred embodiment aluminium is added so that quantity in the molten metal is superior or equal to 0.2% in weight. In a preferred embodiment it is superior or equal to 0.4% in weight. The oxides thus form migrate towards the top of the molten metal and increase the slag amount. The amount of aluminium to be added depends on the acceptable amount of titanium oxides in the slag to limit the slag crystallisation and of the parameters which control the titanium partitioning such as molten metal composition, slag composition and temperature. Among these parameters, main parameters are the titanium content in the molten metal, alloying elements in molten metal such as boron, manganese, chromium . . . which can change the slag/metal equilibrium, respective temperature of molten metal and slag, slag weight/molten metal weight ratio, slag composition. Other slag oxides reducible by titanium such as SiO2, B2O3 must be avoided to limit titanium partitioning,. Calculations of slag/metal thermodynamic equilibrium can be done when thermodynamic models and thermodynamic databases are available.

Thermodynamic calculations are achieved to optimize both aluminium amount to be added and slag composition, based on final TiOₓ target in the slag, molten metal composition and temperature during refining process. For each step of the refining process of the grade, aluminium content in the molten metal and slag composition is optimized to limit titanium partitioning and to guarantee TiOₓ target and limit slag crystallization.

To define optimum conditions, evolution of TiOx and crystallized fraction in the slag is calculated depending on the variability of temperature and molten metal & slag compositions. All those calculations are well known from the skilled person in the steelmaking area. If model & database are not available, slag/metal equilibrium at the laboratory or pilot scale can be done to simulate industrial conditions.

Addition of aluminium allow to deoxidize the molten steel but also to reduce the content of TiOₓ in the slag. One part of slag crystallization occurs through titanates precipitation, titanates being compounds of a titanium oxide combined with other oxide such as an aluminium oxide. By reducing the TiOx content in the slag, precipitation of titanates is limited, leading to lower fraction of crystal. Nature and crystallization rate of titanates can be more or less complex depending on slag composition.

Then, according to the method o the invention, mineral compounds containing aluminium and/or calcium and/or magnesium; such as lime Ca(OH)₂ or magnesia MgO, and up to 25% in weight of spar CaF₂ are added to the molten metal. According to the invention, those additions are done so as to reach and maintain a composition of the slag wherein the ratio of CaO versus Al₂O₃ (C/A) is comprised between 0.7 and 2. This composition allows to limit the crystallisation rate of the titanium oxides present in the slag by maximizing slag sulphur capacity.

Limitation of TiOx thanks to aluminium addition must indeed be associated to optimization of slag composition to optimize the nature and amount of titanates and limit their precipitation in the slag to promote low slag crystallization at the casting temperature.

In a preferred embodiment when the ratio is comprised between 1.4 and 2, the slag contains furthermore between of 6 and 25% in weight of spar CaF₂ and more preferentially between 6 and 12% in weight of spar CaF2. How to calculate and to control this ratio is well known form the man skilled in the art in the steelmaking domain. In another embodiment the ratio C/A is comprised between 0.9 and 1.3 and the slag comprises between 5 and 15% in weight of magnesia. In a third embodiment, this ratio is comprised between 1.4 and 2 and the slag contains between of 6 and 12% in weight of spar CaF₂ and between 5 and 15% in weight of magnesia MgO. Magnesia allows to decrease the liquidus temperature of slag. This last composition allows to further limit the crystallisation rate of the titanium oxides. The magnesia can be added to the melt and/or may come directly from the refractories surrounding the molten metal in the steelmaking vessel. The man skilled in the art knows from experience which quantity of magnesia will be dissolved from the refractories and which quantity needs to be added in order to reach the required content.

Thanks to this slag composition control and to the aluminium addition, the slag contains strictly less than 20% in weight of titanium oxides. In all embodiments the remainder slag composition comprises less than 1% w of B₂O₃, less than 1% w of SiO₂, less than 1% w of CrOₓ, less than 1% w of MnO, less than 1% w of NiO, less than 1% w of FeOₓ. With the method according to the invention no deslagging is necessary before going to the next step which reduces the elaboration time of the steel.

After the mineral addition step, titanium is added to the melt in such a quantity to reach the targeted composition of the final semi-product which is at least superior or equal to 3.5% in weight. This is the nominal composition. This titanium may be added in form of sponge titanium or ferro-titanium pieces such as Fe-70% Ti or Fe-35% Ti, or pure Ti or Ferro-titanium wires.

35%≤CaO≤55%,

15%≤Al203≤55%,

while satisfying 0.7≤CaO2/Al2O3≤2,

0% ≤MgO≤15%,

TiOx<20%

less than 1% of each of the following compounds B2O3, SiO2, CrOx, MnO, NiO, FeOx, S,

0%≤CaF2≤25%

remainder being oxides resulting from the impurities present in the molten metal.

Then the liquid steel thus formed is sent to the casting station to be cast in a form of a semi-product. The casting temperature is lower than or equal to T|iquidus+ 40° C., T|iquidus designating the liquidus temperature of the steel. In present case it is for example around 1330° C. By semi-product it is meant a steel slab, a thick strip or thin slab or any other product made by continuous casting, vertical casting, horizontal casting, roll casting, thin slab casting, bet casting, strip casting.

In another embodiment of a method according to the invention, the semi-product to be cast contains at least 2% in Boron, boron which is added after the mineral addition step by injection of ferro-boron pieces such as Fe-18% B or ferro-boron wires. In a most preferred embodiment, this addition is performed during the mineral addition step,

In a preferred embodiment the steel semi-product has the following composition expressed in content by weight:

0.01%≤C≤0.2%

3.5≤Ti≤10%

(0.45×Ti)−1.35%≤B≤(0.45 ×Ti)+0.70%

S≤0.03%

P≤0.04%

N≤0.05%

O≤0.05%

and optionally containing:

Si≤1.5%

Mn≤3%

Al≤1.5%

Ni≤1%

Mo≤1%

Cr≤3%

Cu≤1%

Nb≤0.1%

V≤0.5%

and comprising precipitates of TiB₂ and optionally of Fe₂B, the balance being Fe and unavoidable impurities resulting from the elaboration. This preferred composition allows the steel to remain mainly ferritic at any temperature below the liquidus temperature and thus reduces castability issues.

One way for the steelmaker to perform the method according to the invention is first to define the target of titanium in the final semi-product and the casting temperature of this final semi-product. Then, to define which slag composition he wants to have within the given frame of the invention, i.e. remaining in the given range of C/A ratio, potentially adding spar, quantity of MgO provided by the refractories . . . depending on the crystallization volume he may tolerate at the casting. Finally, calculating, using known models, the amount of aluminium and other mineral additions needed to reach this defined slag composition.

For all the previously mentioned embodiments the different steps performed on the liquid steel may be performed indifferently in the same vessels, in different vessels, depending on the plant configuration. No specific equipment other than the ones classically used in a steel shop are needed.

### EXAMPLES

The following trials presented hereunder are non-restricting in nature and must be considered for purposes of illustration only. They will illustrate the advantageous features of the present invention.

### Calculation

Calculation were performed using thermodynamic models as previously described, and which are known from the man skilled in the art. Considered temperature of slag was of 1350° C.

Considered parameters are the amount of titanium in the semi-product to be cast (%Ti), the ratio C/A with % CaO and % Al₂O₃ in the slag, the amount of CaF2 (or spar) in the slag and a target maximum amount of TiOₓ in the slag. Calculation were performed considering 15 kg of slag per ton of hot metal

The content in magnesia MgO in slag was always considered at 10% w.

Calculation were performed considering 15 kg of slag per ton of hot metal.

Given all this condition a percentage of crystallisation of the slag representing the percentage in volume of solid phase over the total slag volume was calculated. Thermodynamic calculation gives nature and amount of precipitating oxides into the liquid slag, knowing the volume of liquid slag it is thus possible to determine the percentage in volume of crystallized stag.
Aluminium Addition

In this set of examples, the target of titanium in the final product was varied between 2.5 and 10%. C/A ratio was set at 1.1, no CaF2 was added.

All parameters and results are summed up in table 1 below, trials numbers with a star * are not according to the invention.

TABLE 1

| No | % Ti | C/A | % Al | % TiOx |
|---|---|---|---|---|
| 1* | 2.5 | 1.1 | 0.14 | 5% |
| 2* | 2.5 | 1.1 | 0 | 14.8 |
| 3 | 3.5 | 1.1 | 0.23 | 5% |
| 4* | 3.5 | 1.1 | 0 | 20 |
| 5 | 4 | 1.1 | 0.27 | 5% |
| 6* | 4 | 1.1 | 0 | 21.7 |
| 7 | 5 | 1.1 | 0.34 | 5% |
| 8* | 5 | 1.1 | 0 | 26.9 |
| 9 | 8 | 1.1 | 0.61 | 5% |
| 10* | 8 | 1.1 | 0 | 43.8 |
| 11 | 10 | 1.1 | 0.85 | 5% |
| 12* | 10 | 1.1 | 0 | 50.6 |

From this set of trials, when the target of titanium in the final product is superior or equal to 3.5%, the addition of aluminium is necessary to reduce the amount of TiOx into the slag and thus avoid crystallization of slag.
C/A Ratio

In this set of examples, the target of titanium in the final product was equal to 8 or 10. C/A ratio was varied from 0.5 to 2.3, no CaF2 was added.

Amount of aluminium added is set to 0.4%.

All parameters and results are summed up in table 2 below, trials numbers with a star * are not according to the invention. As previously explained the acceptable amount of crystallization rate depends on the process but an acceptable crystallization rate for a steelmaker is when slag covers the molten metal surface while still allowing sampling in molten metal.

TABLE 2

| No | % Ti | C/A | % Al | % crystallization |
|---|---|---|---|---|
| 20* | 8 | 0.5 | 0.4 | 48.7 |
| 21 | 8 | 07 | 0.4 | 3.8 |
| 22 | 8 | 1.1 | 0.4 | 1.7 |
| 23 | 8 | 1.6 | 0.4 | 4.9 |
| 24 | 8 | 2 | 0.4 | 16.7 |
| 25* | 8 | 2.3 | 0.4 | 24.0 |
| 26* | 10 | 0.5 | 0.4 | 37.4 |
| 27 | 10 | 0.7 | 0.4 | 1.5 |
| 28 | 10 | 1.1 | 0.4 | 1.7 |
| 29 | 10 | 1.6 | 0.4 | 4.1 |
| 30 | 10 | 2 | 0.4 | 15.2 |
| 31* | 10 | 2.3 | 0.4 | 23.2 |

From this set of trials, the addition of mineral compounds to get a slag composition within the C/A range of the invention allows to reduce the crystallisation rate of the slag.
Influence of CaF2 on the aluminium addition

In this set of examples, the target of titanium in the final product was set at 8%.

C/A ratio was set at 1.1 and spar (CaF2) content was varied from 0 to 20% w.

Aluminium content was calculated so as to reach a content of titanium oxides in slag equals to 5%.

All parameters and results are summed up in table 3 below.

TABLE 3

| No | % Ti | C/A | % CaF2 | % Al | % TiOx |
|---|---|---|---|---|---|
| 40 | 8 | 1.1 | 0 | 0.61 | 5 |
| 41 | 8 | 1.1 | 5 | 0.55 | 5 |
| 42 | 8 | 1.1 | 10 | 0.48 | 5 |
| 43 | 8 | 1.1 | 15 | 0.4 | 5 |
| 44 | 8 | 1.1 | 20 | 0.33 | 5 |

Addition of CaF2 allows to reduce the amount of aluminium needed to reduce TiOx content in slag and thus to limit crystallization.
Influence of CaF2 on the crystallization rate

In this set of examples, the target of titanium in the final product was fixed at 8%.

CIA ratio was varied from 1.1 to 2 and spar (CaF2) content was either 0 or 12% w.

Aluminium content was fixed to 0.4%

All parameters and results are summed up in table 4 below.

TABLE 4

| No | % Ti | C/A | % CaF2 | % Al | % crystallization |
|---|---|---|---|---|---|
| 52 | 8 | 1.1 | 0 | 0.4 | 1.7 |
| 53 | 8 | 1.1 | 12 | 0.4 | 0.0 |
| 54 | 8 | 1.6 | 0 | 0.4 | 4.9 |
| 55 | 8 | 1.6 | 12 | 0.4 | 0 |
| 56 | 8 | 2 | 0 | 0.4 | 16.4 |
| 57 | 8 | 2 | 12 | 0.4 | 8.7 |

The addition of spar CaF2 allows to further limit the crystallization rate of the slag.

### Pilot Trials

Trials were performed on a pilot to reproduce steel behaviour at a small scale, Molten metal whose initial composition is given in table 5 was poured into a magnesia crucible placed into a furnace under given conditions of temperature and atmosphere. The presence of argon and thus of a non-oxidizing atmosphere is linked to the configuration of the pilot and is not necessary in industrial conditions. Balls of slag, composition of which are given in table 5, were then added on the top of the molten metal. Results in terms of crystallization are also given in Table 5.

Trial A608 was performed with a method which does not correspond to the invention, while the five other trials are according to the invention. For this trial a standard aluminium value for deoxidation was added to the steel, not more as in the method according to the invention.

Trial A608 is the only one presenting a slag crystallisation at the casting temperature, thus preventing further casting of the steel. The method according to the invention allows thus to avoid crystallisation of the slag at the required casting temperature.

Furthermore, with a method according the partitioning of titanium is preventing and thus less titanium addition is needed to reach the targeted composition.

TABLE 5

| | | | Slag composition | | | | | | Steel | | | | |
|---|---|---|---|---|---|---|---|---|---|---|---|---|---|
| Trial | % Al | | | | | | | Slag | B | | Ti | | |
| No | added | Conditions | C/A | CaF2 | MgO | B₂O₃ | TiO2 | crystallization | Initial | Final | Initial | Final | ΔTi |
| A608* | 0.04% | 1390° C. | 1.6 | — | 3.4 | — | 29.5 | YES | 1.95 | 2.05 | 5.83 | 3.49 | 40.1% |
| | | Ar-1 atm | | | | | | | | | | | |
| A598 | 0.4% | 1425° C. | 1 | — | 8.5 | 0.35 | 7.7 | NO | 1.92 | 1.91 | 5.96 | 5.85 | −1.8% |
| | | Ar-1 atm | | | | | | | | | | | |
| A596 | 0.4% | 1450° C. | 1.1 | — | 7.3 | 0.26 | 4.65 | NO | 1.76 | 1.75 | 5.86 | 5.78 | −1.4% |
| | | Ar-1 atm | | | | | | | | | | | |
| A602 | 0.4% | 1360° C. | 1.1 | — | 7.1 | 0.4 | 4.2 | NO | 1.95 | 1.98 | 5.85 | 5.62 | −3.9% |
| | | Ar-1 atm | | | | | | | | | | | |
| A601 | 0.4% | 1380° C. | 0.7 | 7.4 | 23.4 | 0.9 | 4.9 | NO | 1.95 | 2.01 | 5.83 | 5.52 | −5.3% |
| | | Ar-1 atm | | | | | | | | | | | |
| A610 | 0.6% | 1530° C. | 0.7 | 5-6.5 | 4.7-12.6 | — | 0-20 | NO | 1.95 | 2.04 | 5.83 | 6.08 | +4.3% |
| | | Ar-0.25 atm | | | | | | | | | | | |

What is claimed is:

1-15. (canceled)

16. A method of casting a steel semi-product from a liquid steel, the steel semi-product having a targeted composition in titanium of at least 3.5% in weight, the method comprising the following steps:
A) adding aluminium to the liquid steel so that liquid steel contains at least 0.1% by weight of aluminium;
B) adding mineral components to the liquid steel, the mineral compounds containing CaF2 and aluminium and calcium and optionally magnesium, to reach and maintain a slag with a slag composition wherein the ratio of CaO versus Al₂O₃ (CaO/Al₂O₃) is from 0.7 to 2 and the slag contains up to 25% by weight of CaF2;
C) adding titanium to the liquid steel to reach the targeted composition; and
D) casting the steel in the form of a semi-product.

17. The method as recited in claim 16 wherein the amount of aluminium added is such that the liquid steel contains more than 0.2% in weight of aluminium.

18. The method as recited in claim 17 wherein the amount of aluminium added is such that the liquid steel contains more than 0.4% in weight of aluminium.

19. The method as recited in claim 16 wherein the mineral compounds are chosen from the group consisting of: lime, spar CaF2 and magnesia.

20. The method as recited in claim 16 wherein the steel semi-product contains boron in a minimum percentage in weight fulfilling following equation: % B>0.45×% Ti−1.35%

21. The method as recited in claim 16 further comprising heating the liquid steel between steps A and B.

22. The method as recited in claim 16 wherein further comprising adding boron after step C.

23. The method as recited in claim 16 wherein boron is added during step B.

24. The method as recited in claim 16 wherein during step B, the CaF2 is as spar CaF2 added so as to reach a composition in CaF2 from 6 to 15% in weight.

25. The method as recited in claim 16 wherein during step B, magnesia is added so as to reach a composition in MgO comprised from 5 to 15% in weight.

26. The method as recited in claim 16 wherein during step B the mineral compounds are added to reach the slag composition wherein the ratio of CaO versus Al2O3 (CaO/Al2O3) is between 0.9 and 1.3.

27. The method as recited in claim 16 wherein during step B the mineral compounds are added to reach the slag composition wherein the ratio of CaO versus Al2O3 (CaO/Al2O3) is between 1.4 and 2, the slag furthermore includes between 6 and 12% in weight of CaF2.

28. The method as recited in claim 16 wherein the steel semi-product has a targeted composition in titanium of at least 5.8% in weight.

29. (new The method as recited in claim 16 wherein the steel semi-product has the following composition expressed in content by weight:
0.01%≤C≤0.2%
3.5≤Ti≤10%
(0.45×Ti)−1.35%≤B≤(0.45×Ti)+0.70%
S≤0.03%
P≤0.04%
N≤0.05%
O≤0.05%
and optionally containing:
Si≤1.5%
Mn≤3%
Al≤1.5%
Ni≤1%
Mo≤1%
Cr≤3%
Cu≤1%
Nb≤0.1%
V≤0.5%
and comprising precipitates of TiB₂ and optionally of Fe₂B, a balance being Fe and unavoidable impurities resulting from processing.

30. A steelmaking slag having the following composition, expressed in content by weight:
35%≤CaO≤55%,
15%≤Al₂O₃≤55%,
while satisfying 0.7≤CaO₂/Al₂O₃≤2,
0% ≤MgO≤15%,
TiOx<20%
less than 1% of each of the following compounds B₂O₃, SiO₂, CrOₓ, MnO, NiO, FeOₓ, S,
6%≤CaF₂≤12%
remainder being oxides resulting from the impurities present in the molten metal.
